(19) United States
(12) Patent Application Publication
(10) Pub. No.: US 2014/0367553 A1
(43) Pub. Date: Dec. 18, 2014

(54) System, Method And Apparatus For Deep Slot, Thin Kerf Pixelation

(71) Applicant: Thomas A. Selfe, Huntsburg, OH (US)

(72) Inventor: Thomas A. Selfe, Huntsburg, OH (US)

(21) Appl. No.: 14/241,314

(22) PCT Filed: Aug. 30, 2012
(86) PCT No.: PCT/US12/53130

§ 371 Date: Jul. 10, 2014

Related U.S. Application Data
(60) Provisional application No. 61/528,909, filed on Aug. 30, 2011.

(51) Int. Cl. G01J 1/42; G01J 1/44; G01T 1/20; G01B 11/14

(52) U.S. Cl. CPC G01J 1/4228; G01B 11/14; G01J 1/44; G01T 1/2006
USPC 250/208.1

(57) ABSTRACT

An imaging array may comprise a plurality of imaging pixels that form an array, the array having a high energy end, a light exit end and an axis, and each of the pixels has a pixel width PW orthogonal to the axis; septa positioned in the array such that there is a septum between adjacent ones of the imaging pixels, and each of the septa has a depth D in an axial direction; and an aspect ratio of PW:D less than 0.2.

### BACKGROUND OF THE INVENTION

1. Field of the Disclosure

The present invention relates in general to imaging arrays and, in particular, to a system, method and apparatus for an imaging array with deep slot, thin kerf pixilation.

2. Description of the Related Art

Scintillation detectors are generally used to detect high energy emissions such as high energy photons, electrons or alpha particles that are not easily detected by conventional photodetectors. A scintillator, or scintillation crystal, absorbs high energy emissions and converts the energy to a light pulse. The light may be converted to electrons (i.e., an electron current) with a photodetector such as a photodiode, charge coupled detector (CCD) or photomultiplier tube. Scintillation detectors may be used in various industries and applications including medical (e.g., to produce images of internal organs), geophysical (e.g., to measure radioactivity of the earth), inspection (e.g., non-destructive, non-invasive testing), research (e.g., to measure the energy of photons and particles), and health physics (e.g., to monitor radiation in the environment as it affects humans).

Scintillation detectors typically include either a single large crystal or a large number of small crystals arranged in an array. Many scanning instruments include scintillation detectors that comprise pixelated arrays of scintillation crystals. Arrays can consist of many scintillation pixels that can be arranged in rows and columns. Pixels may be positioned parallel to each other and may be retained in position with an adhesive such as an epoxy. The array may be positioned in an imaging device so that one end of the array (high energy end) receives excitatory energy and the opposed end (light emitting end) transmits resultant light to a photo detector. Light exiting the emitting exit end can be correlated to a specific scintillation event in a specific pixel, and this light can be used to construct a pattern of excitatory energy impacting the high energy end of the array.

The pixels in scintillator arrays are physically separated from each other by dividers or septa. For example, the pixels and septa are generally aligned with and parallel to a central x-ray axis. The geometry of these devices often results in x-rays striking the array with more oblique angles at the edges than in the center. The angled trajectories of the x-rays lead to more energy sharing between the pixels due to Compton scattering relative to the axial direction of the original x-ray.

The septa between pixels can be formed with a thin circular carbide saw blade. The blade has a thickness of about 0.3 to 0.4 mm. Deeper septa inherently require greater widths due to the dynamics of forming the slots with a rotating saw blade. This results in wider septa and larger pixels, which diminishes the resolution of the array image. Deep cutting with a blade causes increases in friction, coolant drag on the sides of the blade, and blade path wandering. These factors can result in broken or fractured pixels or misaligned septa. As depth of cut increases, more of the blade in in contact with the crystal, increasing the risk of crystal breakage. Thus, improvements in imaging array design and implementation continue to be of interest.

### SUMMARY

Embodiments of a system, method and apparatus for an imaging array may comprise a plurality of imaging pixels that form an array, the array having a high energy end, a light exit end and an axis, and each of the pixels has a pixel width PW orthogonal to the axis; septa positioned in the array such that there is a septum between adjacent ones of the imaging pixels, and each of the septa has a depth D in an axial direction; and an aspect ratio of PW:D less than 0.2. In other embodiments, a machine may comprise a source of radiant energy for emitting energy; an imaging array comprising embodiments as described elsewhere herein; an output device for displaying an image from the light exit end; and a user interface coupled to the source of radiant energy and output device.

The foregoing and other objects and advantages of these embodiments will be apparent to those of ordinary skill in the art in view of the following detailed description, taken in conjunction with the appended claims and the accompanying drawings.

### BRIEF DESCRIPTION OF THE DRAWINGS

So that the manner in which the features and advantages of the embodiments are attained and can be understood in more detail, a more particular description may be had by reference to the embodiments thereof that are illustrated in the appended drawings. However, the drawings illustrate only some embodiments and therefore are not to be considered limiting in scope as there may be other equally effective embodiments.

FIG. 1 is a schematic isometric view of an embodiment of a scintillation array;

FIG. 2 is a sectional top view of an embodiment of an array;

FIGS. 3 and 4 are side and end views of another embodiment of an array during manufacturing.

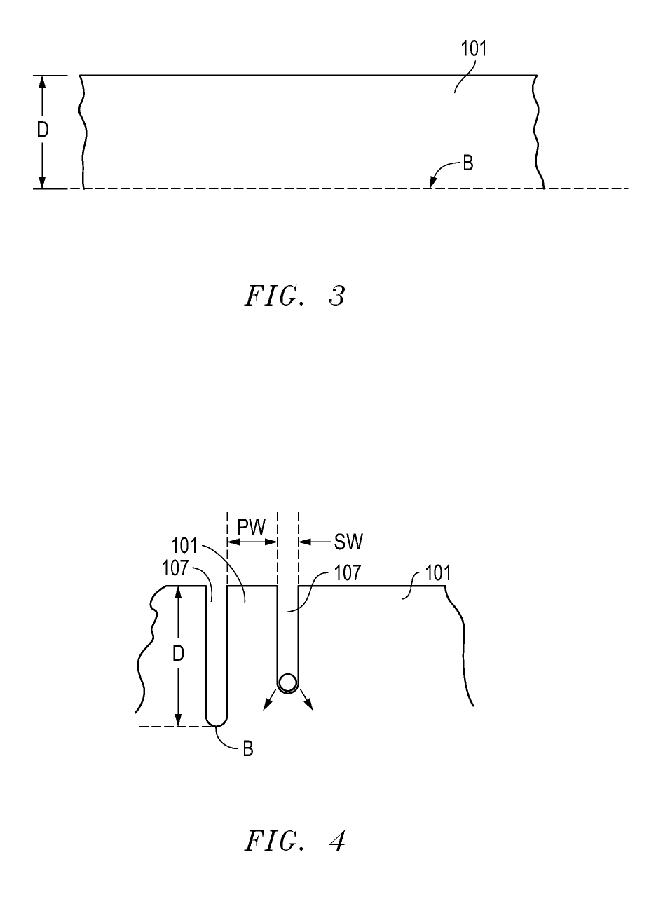

The use of the same reference symbols in different drawings indicates similar or identical items.

### DETAILED DESCRIPTION

Scintillation detectors are generally used to detect relatively high energy photons, electrons or alpha particles wherein high energy is 1 KeV or higher, including gamma rays, alpha particles and beta particles. It may be appreciated that these photons, electrons or alpha particles may not be easily detected by conventional photodetectors, which may, for example, be sensitive to photons at wavelengths of 200 nm or greater, including 200 nm to 800 nm. A scintillator, or scintillation crystal, ceramic or plastic, absorbs excitatory waves or particles and converts the energy of the waves or particles to a light pulse. The light may be converted to electrons (i.e., an electron current) with a photodetector such as a photodiode, charge-coupled detector (CCD) or photomultiplier tube.

As used herein, the term “high energy surface” or “high energy end” denotes the surface of a scintillation array or pixel through which high energy photons, electrons or alpha particles first enter. “Detectable light” is the light output by a scintillator that can be detected by a photodetector. Detectable light has a wavelength in the range of 200 to 700 nm. A “photodetector” converts detectable light emitted from a scintillation crystal into an electrical signal. The term “optically coupled” refers to at least one coupled element being adapted to impart light to another coupled element directly or indirectly.

The term “scintillator” refers to a material that emits light (“scintillation light”) in response to high energy photons, electrons or alpha particles wherein high energy is 1 KeV or higher (“excitatory energy”). This excitatory energy includes gamma rays, alpha particles and beta particles incident thereon. Known scintillators include materials such as ceramic, crystal and polymer scintillators. A “scintillation crystal” is a scintillator made primarily of inorganic crystal. “Scintillation pixels” are known to those of skill in the art and comprise individual scintillators that are each associated with one or more photodetectors.

Multiple scintillation pixels can be associated together to form a “scintillation array.” The array may be associated with one or more photodetectors. The detectable light from each pixel can be independently detected. The pixels may be separated from each other and may be joined via a common substrate. An “adhesive” as used herein is a material that can be used to join independent pixels together in an array or to preserve the spacing between pixels. A “diffuse” reflective material reflects a given ray of visible light in multiple directions. A “specular” reflective material reflects a given ray of visible light in a single direction. A material is “transparent” to visible light if it allows the passage of more than 50% of the visible light that impacts the material. A material is “opaque” if it blocks 80% or more of the visible light that impacts the material.

Scintillation detectors may be used in various industries and applications including medical (e.g., to produce images of internal organs), geophysical (e.g., to measure radioactivity of the earth), inspection (e.g., non-destructive, non-invasive testing), research (e.g., to measure the energy of photons and particles), and health physics (e.g., to monitor waves or particles in the environment as it affects humans).

Medical devices may include positron emission tomography scanners, gamma cameras, computed tomography scanners and radioimmunoassay applications. Geophysical devices may include well logging detectors. Inspection devices may include radiance detectors, such as thermal neutron activation analysis detectors, luggage scanners, thickness gauges, liquid level gauges, security and manifest verification, both active and passive devices, spectroscopy devices (radioisotope identification devices), both active and passive devices, and gross counters, both active and passive. Research devices may include spectrometers and calorimeters. Health physics applications may include laundry monitoring and area monitoring.

Scintillation arrays often are composed of a group of scintillating pixels arranged in rows and columns to produce the array. Scintillation pixels may be inorganic or organic. Examples of inorganic scintillation pixels may include crystals such as thallium doped sodium iodide (NaI(Tl)) and thallium doped cesium iodide (CsI(Tl)). Additional examples of scintillation crystals may include barium fluoride, cerium-doped lanthanum chloride (LaCl₃(Ce)), bismuth germinate (Bi₄Ge₃O₁₂), cerium-doped yttrium aluminum garnet (Ce:YAG), cerium-doped lanthanum bromide (LaBr₃(Ce)), lutetium iodide (LuI₃), calcium tungstate (CaWO₄), cadmium tungstate (CdWO₄), lead tungstate (PbWO₄), zinc tungstate (ZnWO₄) and lutetium oxyorthosilicate (Lu₂SiO₅), as well as cerium doped-lutetium yttrium oxyorthosilicate (Lu_{1.8}Y_{0.2}SiO₅(Ce)) (LYSO). Scintillators may also include inorganic ceramics such as terbium-doped gadolinium oxysulfide (GOS(Tb)), and europium doped lutetium oxide (Lu₂O₃(Eu)). In addition, examples of organic scintillators may include polyvinyltoluene (PVT) with organic fluors present in the PVT as well as other polymer materials. For example, one application may include hydroscopic materials such as NaI.

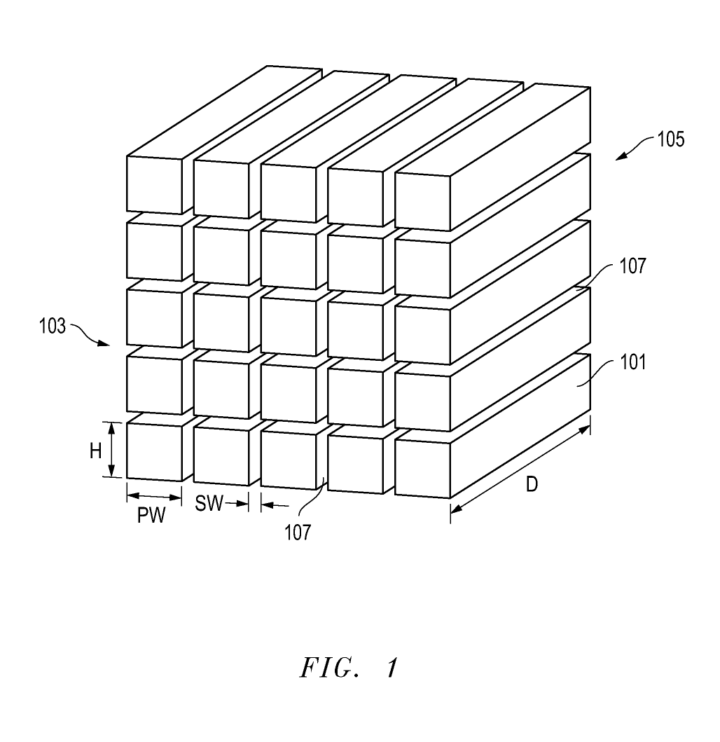

Arrays may include any number of scintillation pixels and pixels may be made of, for example, crystalline or polymeric material. As shown in the schematic drawings of FIG. 1, the depth D of imaging (e.g., scintillation) pixel 101 is greater than the width PW and/or height H of pixel 101. The array can be placed in association with an imaging device so that high energy end 103 of the array is oriented toward the excitatory energy source. Light exiting end 105 can be associated with a photodetector so that light resulting from scintillation events can be detected.

Each individual pixel may have one or a plurality of photodetectors associated with it. Space 107 between pixels may be occupied by a reflective, opaque material designed to channel light to light exiting end 105 of the array while minimizing crosstalk between pixels. In this manner, light generated within a specific pixel can be detected by a photodetector associated with that same pixel or by a portion of a photodetector associated with that pixel.

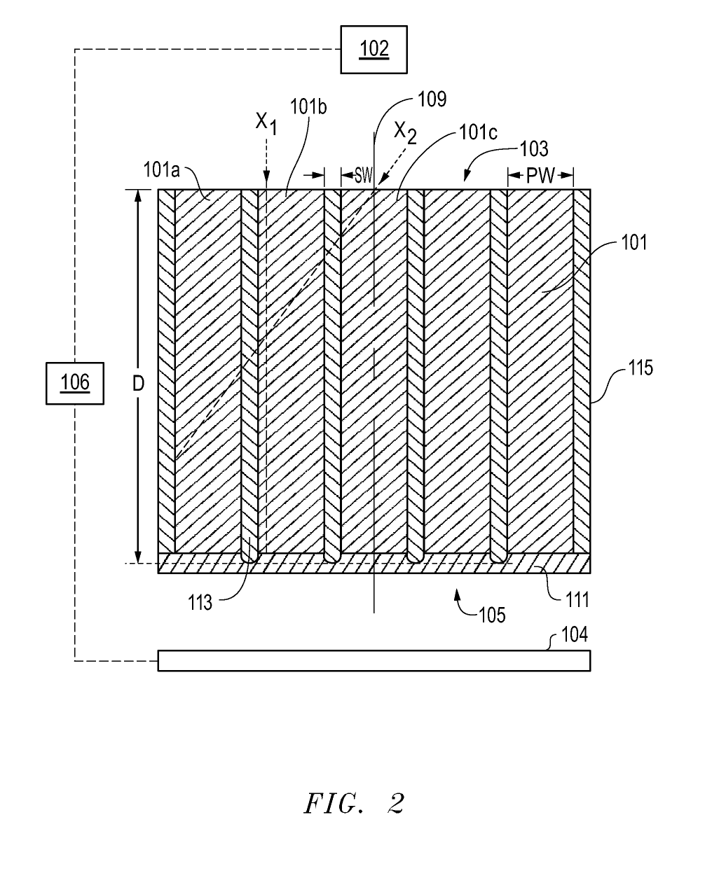

FIG. 2 provides a sectional view of a scintillation array showing the positioning of five pixels. As shown, high energy end 103 is at the top of the figure and light exit window 111 is at the bottom, although visible light also may exit from the high energy end 103. Pixels 101, 101a, 101b and 101c include septum or reflective barriers 113 formed in the spaces 107 (FIG. 1) separating the adjacent pixels. If excitatory energy enters the scintillation array along a path that is parallel to the depth of the pixels (direction X₁) the resulting scintillation event will take place in pixel 101b, regardless of how deep within the pixel the event occurs. However, if the excitatory energy enters the array at an angle (direction X₂), the resulting scintillation event may occur in any of pixels 101c, 101b or 101a, depending on how far the excitatory energy penetrates the array before scintillating. If the resulting scintillation event occurs in either pixel 101b or 101a, the resulting light will be detected as having occurred in 101b or 101a, rather than in pixel 101c, the first pixel penetrated by the excitatory energy. These parallax effects can cause distortion in the reconstructed image.

The array also has an axial center 109 and a perimeter 115. In some embodiments, an output device 104 is provided for displaying an image from the light exit end 111, such as an optical window. A user interface 106 may be coupled to a source of radiant energy 102 and the output device 104. In some embodiments, computations may be performed after images are acquired, such as flat-fielding or tomographic reconstructions, as is known to those of ordinary skill in the art.

In some embodiments, an imaging array comprises a plurality of imaging pixels that form an array. The array has a high energy end 103, a light exit end 105 and an axis 109. Each of the pixels has a pixel width PW orthogonal to the axis 109. Septa 113 are positioned in the array such that there is a septum between adjacent ones of the imaging pixels 101. Embodiments of each of the septa 113 has a depth D in the axial direction, and an aspect ratio of PW:D is less than 0.15. In other embodiments, the aspect ratio is about 0.1 to 0.067. For example, PW may be about 1 mm including pixels at a circumferential perimeter of the array, or PW may be about 2 mm including pixels at a circumferential perimeter of the array.

The slots 107 and septa 113 may extend axially completely through the pixels and into an optical window 111 (FIG. 2) at the light exit end 105. Alternatively, at least some of the slots 107 and septa 113 do not extend axially completely through the pixels 101. See, e.g., FIG. 4. Each of the septa may have a septa width SW that is orthogonal to the axis and is about 0.2 mm.

The surface area of the array may be in a range of about 4 cm² to about 8 cm² for some embodiments, and about 193 cm² to about 930 cm² or more for other embodiments, depending on the machine used to fabricate the array. Embodiments of each of the septa between pixels may have a bottom adjacent the light exit end and the bottoms are radiused as shown. Moreover, each of the septa may have radii of the bottoms that are about half of SW.

The following table compares conventional arrays (in the white rows) to embodiments of arrays in the shaded rows.

Pixillated Array Manufacturing Table Comparing Conventional Arrays to Embodiments of Arrays

| | Maximum | Slot Width. | Maximum | | Edge pixels | |
|---|---|---|---|---|---|---|
| | Pixel Height | (Blade | Surface | Outer Row | Cracked | |
| Pixel Width | (slot depth) | thickness) | Area | Requirements | Permissible | Comments |
| 1 mm pixel | 5 mm | > or =0.2 mm | 258 cm² | 2-3 mm wide | Yes | No round or |
| arrays | | | | pixels on | | curved |
| (conventional) | | | | outer edges | | geometry. |
| | | | | | | Must be |
| | | | | | | square or |
| | | | | | | rectangular |
| 1 mm pixel | 10-15 mm | 0.2 mm | Flexible | Not required | No | Round or |
| arrays | | | | | | curved |
| | | | | | | permissible |
| 2 mm pixel | 10 mm | > or =0.25 mm | 323 cm² | No if height <6 | No | No round or |
| arrays | | | | mm. 3 mm wide | | curved |
| (conventional) | | | | if height >6 mm | | geometry. |
| | | | | | | Must be |
| | | | | | | square or |
| | | | | | | rectangular |
| 2 mm pixel | 20-30 mm | 0.2 mm | Flexible | Not required | No | Round or |
| arrays | | | | | | curved |
| | | | | | | permissible |
| 3 mm pixel | 20 mm | > or =0.25 mm | 323 cm² | Not required | No | No round or |
| arrays | | | | | | curved |
| (conventional) | | | | | | geometry. |
| | | | | | | Must be |
| | | | | | | square or |
| | | | | | | rectangular |
| 3 mm pixel | 30-45 mm | 0.2 mm | Flexible | Not required | No | Round or |
| arrays | | | | | | curved |
| | | | | | | permissible |
| 4 mm pixel | 25 mm | > or =0.3 mm | 387 cm² | Not required | No | No round or |
| arrays | | | | | | curved |
| (conventional) | | | | | | geometry. |
| | | | | | | Must be |
| | | | | | | square or |
| | | | | | | rectangular |
| 4 mm pixel | 40-55 mm | 0.2 mm | Flexible | Not required | No | Round or |
| arrays | | | | | | curved |
| | | | | | | permissible |

In other embodiments, a machine comprises a source of radiant energy for emitting energy; an imaging array, comprising: a plurality of imaging pixels that form an array, the array having a high energy end for receiving the emitted energy, a light exit end, an axial center and a radial perimeter; septa positioned in the array such that there is a septum between adjacent ones of the imaging pixels; and the septa are as described elsewhere herein; an output device for displaying an image from the light exit end; and a user interface coupled to the source of radiant energy and output device.

In some embodiments, the process may utilize a machine such as a Meyer Burger SG-1. Such machines cut the slots in the crystal to form the septa with one or more reciprocating grit-coated wires. For example, a gang of diamond grit coated wires may be arranged to simultaneously cut all slots in one direction while the part is fed up against the wires. Embodiments of the wire comprise a diameter of about 0.2 mm and can cut to depths beyond that of a saw blade. The wire produces lower cutting forces on the crystal than the blade due to contact only at a bottom of the slot where the crystal is thicker and stronger, no side load against the cut portions of the pixels, and minimal coolant drag. This allows for the manufacture of an array with longer, thinner pixels, and thinner septa, resulting in improved detector resolution.

In still other embodiments, an imaging array may comprise a plurality of imaging pixels that form an array, the array having a high energy end, a light exit end and an axis, and each of the pixels has a pixel width PW orthogonal to the axis; septa positioned in the array such that there is a septum between adjacent ones of the imaging pixels, and each of the septa has a depth D in an axial direction such that an aspect ratio is defined as PW:D; wherein for a PW of no more than about 2mm, the aspect ratio is less than 0.2; or for a PW of at least about 3 mm, the aspect ratio is less than 0.15.

For the PW of no more than about 2 mm, the aspect ratio may be less than about 0.18, less than about 0.16, less than about 0.14, less than about 0.12, less than about 0.10, less than about 0.09, less than about 0.08, or less than about 0.07. For the PW of at least about 3 mm, the aspect ratio may be less than about 0.14, less than about 0.13, less than about 0.12, less than about 0.11, less than about 0.10, less than about 0.09, or less than about 0.08.

In some embodiments, the septa extend axially completely through the pixels and into an optical window at the light exit end. At least some of the septa may not extend axially completely through the pixels. Each of the septa may have a septa width SW substantially orthogonal to the axis that is in a range of about 0.1 mm to about 0.3 mm, or about 0.2 mm. A surface area of the array may be in a range of about 193 cm² to about 930 cm². PW may be the same for each pixel, and may be about 1 mm to 4 mm, including pixels at a perimeter of the array. Each of the septa between pixels may have a bottom adjacent the light exit end and the bottoms are cylindrical in shape. Each of the septa may have a septa width SW substantially orthogonal to the axis, and substantially planar walls.

In other embodiments, a machine comprises a source of radiant energy for emitting energy; an imaging array, comprising: a plurality of imaging pixels that form an array, the array having a high energy end, a light exit end and an axis, and each of the pixels has a pixel width PW orthogonal to the axis; septa positioned in the array such that there is a septum between adjacent ones of the imaging pixels, and each of the septa has a depth D in an axial direction such that an aspect ratio is defined as PW:D; wherein for a PW of no more than about 2 mm, the aspect ratio is less than 0.2; or for a PW of at least about 3 mm, the aspect ratio is less than 0.15; an output device for displaying an image from the light exit end; and a user interface coupled to the source of radiant energy and output device.

Still other embodiments comprise a position-sensitive photosensor (PSPS), such as a position-sensitive photomultiplier tube (PSPMT) with multiple anodes, or a silicon-based photomultiplier (SiPM). The PSPS may comprise an array having two dimensions of photosensitive elements that are configured to determine an x-y location of a photon; the array comprising: a plurality of imaging pixels having a high energy end, a light exit end and an axis, and each of the pixels has a pixel width PW orthogonal to the axis; septa located between adjacent ones of the imaging pixels, and each of the septa has a depth D in an axial direction such that an aspect ratio is defined as PW:D; wherein for a PW of no more than about 2 mm, the aspect ratio is less than 0.2; or for a PW of at least about 3 mm, the aspect ratio is less than 0.15.

For these latter embodiments, the term septa may be used to describe the gaps in the anodes of a PSPMT, even though there may be no structure in the gaps. In some embodiments, the anodes and SiPMs may be generally square in shape, and may range in size from about 0.5 mm² to about 10 mm.

This solution has the manufacturing advantage of providing a radiused cutting edge during fabrication to reduce stress on the crystal being cut. As the slots are being made, conventional saw blades form square-cornered slots that create stress risers and points of potential crack propagation, which can lead to array failure. In contrast, the round wire system and method of the embodiments disclosed herein avoid cornered slots.

This written description uses examples to disclose the embodiments, including the best mode, and also to enable those of ordinary skill in the art to make and use the invention. The patentable scope is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

Note that not all of the activities described above in the general description or the examples are required, that a portion of a specific activity may not be required, and that one or more further activities may be performed in addition to those described. Still further, the orders in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

1. An imaging array, comprising:
a plurality of imaging pixels that form an array, the array having a high energy end, a light exit end and an axis, and each of the pixels has a pixel width PW orthogonal to the axis;
septa positioned in the array such that there is a septum between adjacent ones of the imaging pixels, and each of the septa has a depth D in an axial direction such that an aspect ratio is defined as PW:D; wherein
for a PW of no more than about 2 mm, the aspect ratio is less than 0.2; or
for a PW of at least about 3 mm, the aspect ratio is less than 0.15.

2-3. (canceled)

4. An imaging array according to claim 1, wherein the septa extend axially completely through the pixels and into an optical window at the light exit end.

5. An imaging array according to claim 1, wherein at least some of the septa do not extend axially completely through the pixels.

6. An imaging array according to claim 1, wherein each of the septa has a septa width SW substantially orthogonal to the axis that is in a range of about 0.1 mm to about 0.3 mm.

7. (canceled)

8. An imaging array according to claim 1, wherein a surface area of the array is in a range of about 4 cm² to about 8 cm².

9. An imaging array according to claim 1, wherein PW is the same for each pixel, and is about 1 mm to about 4 mm, including pixels at a perimeter of the array.

10. An imaging array according to claim 1, wherein each of the septa between pixels has a bottom adjacent the light exit end and the bottoms are cylindrical in shape.

11. An imaging array according to claim 1, wherein each of the septa has a septa width SW substantially orthogonal to the axis, and substantially planar walls.

12. A machine, comprising:
a source of radiant energy for emitting energy;
an imaging array, comprising:
a plurality of imaging pixels that form an array, the array having a high energy end, a light exit end and an axis, and each of the pixels has a pixel width PW orthogonal to the axis;
septa positioned in the array such that there is a septum between adjacent ones of the imaging pixels, and each of the septa has a depth D in an axial direction such that an aspect ratio is defined as PW:D; wherein
for a PW of no more than about 2 mm, the aspect ratio is less than 0.2; or
for a PW of at least about 3 mm, the aspect ratio is less than 0.15;
an output device for displaying an image from the light exit end; and
a user interface coupled to the source of radiant energy and output device.

13-14. (canceled)

15. A machine according to claim 12, wherein the septa extend axially completely through the pixels and into an optical window at the light exit end.

16. A machine according to claim 12, wherein at least some of the septa do not extend axially completely through the pixels.

17. A machine according to claim 12, wherein each of the septa has a septa width SW substantially orthogonal to the axis that is about 0.1 mm to about 0.3 mm.

18-19. (canceled)

20. A machine according to claim 12, wherein PW is the same for each pixel, and is about 1 mm to 4 mm, including pixels at a perimeter of the array.

21-22. (canceled)

23. A position-sensitive photosensor (PSPS), comprising:
an array having two dimensions of photosensitive elements that are configured to determine an x-y location of a photon; the array comprising:
a plurality of imaging pixels having a high energy end, a light exit end and an axis, and each of the pixels has a pixel width PW orthogonal to the axis;
septa located between adjacent ones of the imaging pixels, and each of the septa has a depth D in an axial direction such that an aspect ratio is defined as PW:D; wherein
for a PW of no more than about 2 mm, the aspect ratio is less than 0.2; or
for a PW of at least about 3 mm, the aspect ratio is less than 0.15.

24. A PSPS according to claim 23, wherein the PSPS is a silicon-based photomultiplier (SiPM).

25. A PSPS according to claim 23, wherein the PSPS is a position-sensitive photomultiplier tube (PSPMT) with multiple anodes.

26-27. (canceled)

28. A PSPS according to claim 23, wherein the septa extend axially completely through the pixels and into an optical window at the light exit end.

29. A PSPS according to claim 23, wherein at least some of the septa do not extend axially completely through the pixels.

30. A PSPS according to claim 23, wherein each of the septa has a septa width SW substantially orthogonal to the axis that is in a range of about 0.1 mm to about 0.3 mm.

31-32. (canceled)

33. A PSPS according to claim 23, wherein PW is the same for each pixel, and is about 1 mm to 4 mm, including pixels at a perimeter of the array.

34-35. (canceled)
